(19) United States
(12) Patent Application Publication
(10) Pub. No.: US 2015/0075412 A1
(43) Pub. Date: Mar. 19, 2015

(54) Carbon Sequestration in Municipal Solid Waste to Energy Plants

(71) Applicant: Surendra Saxena, Miami, FL (US)

(72) Inventor: Surendra Saxena, Miami, FL (US)

(21) Appl. No.: 14/509,616

(22) Filed: Oct. 8, 2014

Related U.S. Application Data
(63) Continuation of application No. 13/640,257, filed on Oct. 9, 2012.
Application No. 13/640,257 is a continuation-in-part of application No. 13/161,747, filed on Jun. 16, 2011, now abandoned.

(51) Int. Cl. F23G 5/12; B01D 53/62; C10J 3/72; C01B 3/00

(52) U.S. Cl. CPC F23G 5/12; C01B 3/00; B01D 53/62; C10J 3/723; F23G 2900/50204; C10J 2300/0946; C10J 2300/093; C10J 2300/1815
USPC 110/346; 423/648.1; 423/210; 252/372

(57) ABSTRACT

This invention describes a process for a complete sequestration of carbon (CO₂) from Municipal Solid Waste (MSW) to energy plants which produce Refuse Derived Fuel and the associated exhaust gases. The described process results in production of energy from the waste and disposal of the MSW with zero carbon emission.

### CROSS REFERENCE TO RELATED APPLICATIONS

This application is a Continuation-in-Part of application Ser. No. 13/161,747, filed Jun. 16, 2011, claiming priority under 35 USC 120, the entire contents of which are incorporated herein by reference in their entirety.

### STATEMENT REGARDING FEDERALLY SPONSORED RESEARCH OR DEVELOPMENT

No federal government funds were used in researching or development this invention.

### NAMES OF PARTIES TO A JOINT RESEARCH AGREEMENT

Not applicable.

### SEQUENCE LISTING INCLUDED AND INCORPORATED BY REFERENCE HEREIN

table or a computer list appendix on a compact disc

[ ] is

[X] is not

included herein and the mater on the disc, if any, is incorporated-by-reference herein.

### BACKGROUND

1. Field of the Invention

This invention describes a system of processes for sequestering carbon in municipal solid waste (MSW) plants which use the industrial method of incinerating the solid waste and may also be generating refuse derived fuel (RDF). This is achieved by balancing the masses of feedstock and energy such that the end result is hydrogen, sequestered or captured carbon dioxide and residual energy to be used in other applications. The invention will be used to provide hydrogen with zero or highly reduced carbon emission in a plant that produces RDF and/or burns solid waste. The invention is very specific to MSW flue gases and uses the flue gases in RDF plants.

The current industrial method of incineration generates several tonnes of carbon dioxide for each tonne of MSW. The method proposed here produces hydrogen and RDF with zero carbon emission.

2. Background of the Invention

All over the globe, we have a problem of garbage disposal. In many municipalities, the garbage is either buried occupying huge parcels of land or is burnt, generating significant carbon emissions. There is an urgent need to develop innovative solutions to reduce the emissions from coal or gas burning power plants, as well as the plants incinerating solid waste. The present invention addresses carbon sequestration and hydrogen production from MSW plants that incinerate waste and thereby addresses the problem of greenhouse gas emissions and air pollution from many city incinerating facilities. The chemical processes sequester carbon gases (thus preventing them from escaping to the atmosphere) and generate hydrogen with zero carbon emission.

Hydrogen is widely regarded as the energy of the future, but to produce and use hydrogen—either by direct combustion or in a fuel cell—it is necessary to use other sources of energy. Thus, using hydrogen or any other material to produce energy cannot be environmentally clean and economically viable unless the process by which it is produced is free of greenhouse gas emissions. The use of hydrogen is being promoted on a federal level with financial support, and we may eventually have hydrogen-using technology for our transportation and other energy needs. However, the production of the hydrogen for energy will most likely remain dependent on the burning of fossil fuels for the foreseeable future, thereby limiting the viability of such hydrogen use. Solving this problem requires alternative methods to produce hydrogen. The technology disclosed herein uses flue gases produced by MSW plants, coal or natural gas power plants to produce hydrogen by sequestering carbon from such emitted gases.

The invention provides a clear economic incentive to sequester carbon (CO₂) in MSW plants. Current prior art that deals with carbon sequestration does not specifically disclose MSW plants.

What is needed is a process for chemically sequestrating carbon from the emissions of MSW plants.

### SUMMARY OF THE INVENTION

The present invention provides for a system of reactions to sequester carbon and produce hydrogen and carbonate/bicarbonate using MSW and coal or natural gas plants. The sequence of the reactions with mass balances of feedstock is such that all carbon dioxide and other gases that are produced in burning MSW are streamed into a reactor which performs the steam-coal/natural gas-reformation (See, FIGS. 1 and 2, Reactor 3). The MSW-RDF plants use scrubbing methods to get rid of all impurities such as sulfur and mercury such that the resulting gas consists solely of CO2, water, oxygen and nitrogen.

The energy is obtained by burning coal or methane in reduced oxygen conditions in Reactor 1, giving us hot CO. The heat from the hot CO is used to provide heat to Reactor 2 which has the modified steam-methane/coal reaction going on producing carbonate and hydrogen. In Reactor 3, the high temperature CO is combined with sodium hydroxide which then reacts at low temperature according to the reaction proposed herein below. The reaction of CO with sodium hydroxide is exothermic and hence no additional heating is required. The CO reacts to form sodium carbonate and thus carbon is sequestered.

The soda produced in the two reactors is combined and transferred to a 4^{th} reactor where it forms a concentrated aqueous solution and allowed to react with the RDF flue gas to form the sodium bicarbonate. In addition to the production of bicarbonate and hydrogen, we produce a significant amount of heat which can be used for other applications such as providing hot water to the community or to the RDF plant where needed.

We provide a method for the carbon sequestration for the MSW-RDF plants which incinerate solid waste to provide electricity, wherein we balance reactant and product masses so that the net result is production of useful products, specifically soda or sodium bicarbonate, hydrogen and energy. The invention does not require production of any new sodium hydroxide for the hydrogen production, but uses the already-produced solid as a byproduct of chlorine production. This procedure does not lead to any additional release of carbon dioxide from the manufacturing of sodium hydroxide but actually mitigates the carbon emission that occurs due to the production of sodium hydroxide.

An embodiment of the present invention provides for the conversion of CO₂ generated from the flue gases from the MSW-RDF plants for sequestering carbon.

Another embodiment of the invention provides for the balancing of the amount of fuel (coal or natural gas) to generate heat for the SMR reaction of Reactor 2 by heating the reactor walls by conduction.

Another embodiment of the invention provides for the transfer of the product (CO) of Reactor 1 (FIG. 1-2) (CO) to reactor 3 (FIG. 1-2).

Another embodiment of the invention provides for the reaction of sodium hydroxide with CO of reactor 1 and the production of thermal energy, carbonate and hydrogen. In such a case, sodium hydroxide reacts with CO producing hydrogen and carbonate and no carbon is released to the environment.

Another embodiment of the present invention provides for further sequestration of CO₂ by reaction of the Na₂CO₃ with water and CO₂.

Another embodiment of the invention provides for the use of the additional thermal energy generated in reactors 3 and 4 for any purpose as required.

Another embodiment of the invention provides for the formation of concentrated aqueous solution of soda and its conversion to bicarbonate.

The invention further provides for the selling of a mixture of nitrogen and hydrogen to industry.

The invention also provides for separation of pure hydrogen and its use for industrial applications.

The invention also provides for the purification of nitrogen and its sale.

In another embodiment of the invention, we may skip our own production of the carbonate to benefit from the market conditions and obtain it from the market and proceed directly to sequester carbon in the 4^{th} reactor.

### Relation to Other Published Work and Patented Processes

The use of hydroxide in sequestering carbon from processes using fossil-fuel has been suggested in many publications and in some patents (Table 1). The carbonation reaction is well known in the art. A technique to use the carbonation reaction for use with coal-burning power plants using the reaction:

NaOH+CO₂=Na₂CO₃ (or bicarbonate)

Similarly, the reaction (2NaOH+CO+H₂O=Na₂CO₃+H₂) is used for hydrogen production at low temperatures.

This work is specific to the MSW-RDF plants. Such plants are not going to be very large and as such are easily manageable by municipalities of different sizes. The strategy adopted in this work differs from that proposed in other studies. It refers to flue gas composition as are obtained in the incineration of the MSW and the carbonation is specific to such compositions. We will totally eliminate any carbon emission from the MSW-RDF plants by converting all CO₂ to bicarbonate. Prior art does not disclose the SMR reaction for part of the hydrogen production. Sequestration of carbon in the production of RDF and some hydrogen with zero emission and using the carbonate and the heat produced from the reaction gainfully are important aspects of the present invention. Unlike the reactions used in this invention, this method relies on a single direct carbonation reaction. Others have used solids such as CaS and CaO, with different effects. Others use hydroxide reaction with CO₂ involving CaO, magnesium and calcium silicates and alkali hydroxide. Finally the ZECA (Zero Emission Coal Alliance) process uses Ca(OH)₂.

Another important difference with other method is that we do not produce any new sodium hydroxide and avoid the problem of producing chlorine with massive carbon emission. The use of already produced by product hydroxide makes the application limited but has the potential to make some significant difference in the carbon emitted by the chlor-alkali plants.

### BRIEF DESCRIPTION OF THE DRAWINGS

The purpose of this invention and the tremendous advantages it entails for reduction in carbon emission during RDF production needs to be fully understood from the study of the description along with the drawings herein.

FIG. 1. This figure shows a series of vessels marked as Reactor 1 to 4. The reactor 1 is to burn coke or natural gas under reduced oxygen or air flow to produce heat and CO (plus N2 if air is used). The hot gas at nearly a temperature of 1000 C is passed through activated charcoal to absorb heavy metals and then surrounds the second reactor imparting heat for the endothermic reaction of coke, water and NaOH with production of carbonate and hydrogen. The hot CO (plus N2 if air is used) finds its way to the third reactor where it reacts with NaOH to form carbonate and hydrogen or hydride as required.

FIG. 2. This figure shows a series of vessels marked as Reactor 1 to 4. The reactor 1 is to burn coke or natural gas under reduced oxygen or air flow to produce heat and CO (plus N2 if air is used). The hot gas at nearly a temperature of 1000 C is passed through activated charcoal to absorb heavy metals and then surrounds the second reactor imparting heat for the endothermic reaction of clean natural gas, water and NaOH with production of carbonate and hydrogen. The hot CO (plus N2 if air is used) finds its way to the third reactor where it reacts with NaOH to form carbonate and hydrogen or hydride as required.

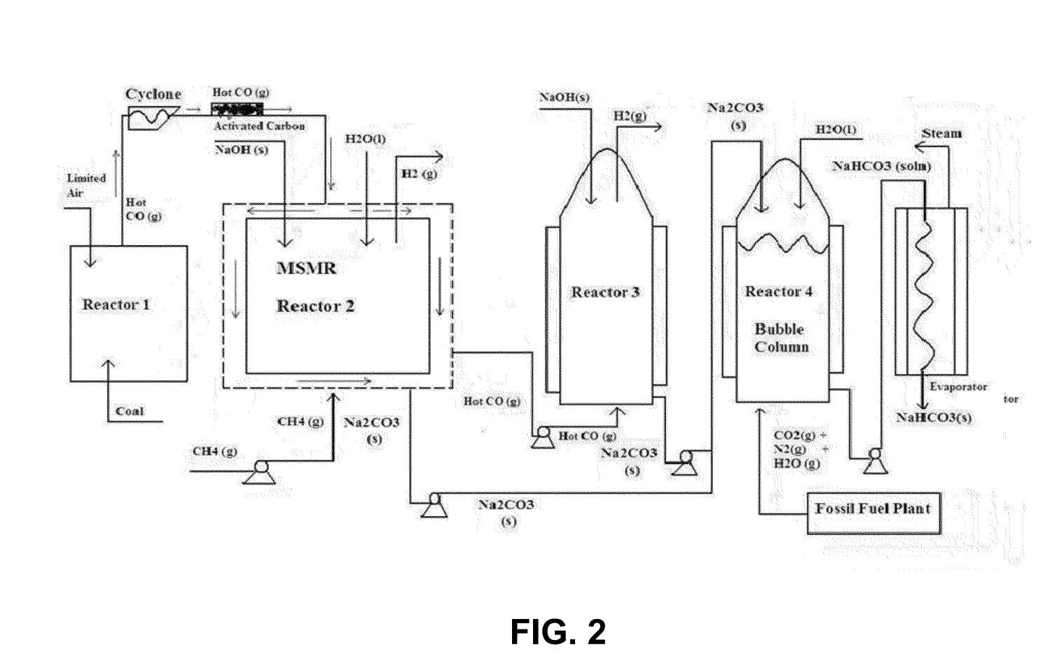

FIG. 3 shows the essential cabon sequestration process from the MSW plant. The carbonate from the two reactor vessels is fed into a rotating vessel to make a concentrated solution of the cabonate. The RDF gas (composition as given in the examples) is fed into this fourth reactor with water and carbonate in prescribed amounts (see example). The precipitated bicabonate with solution is fed to a centrifuge where the bicarbonate crystals are separated and sent for drying. The remaining concentrated solution is returned and the process is repeated.

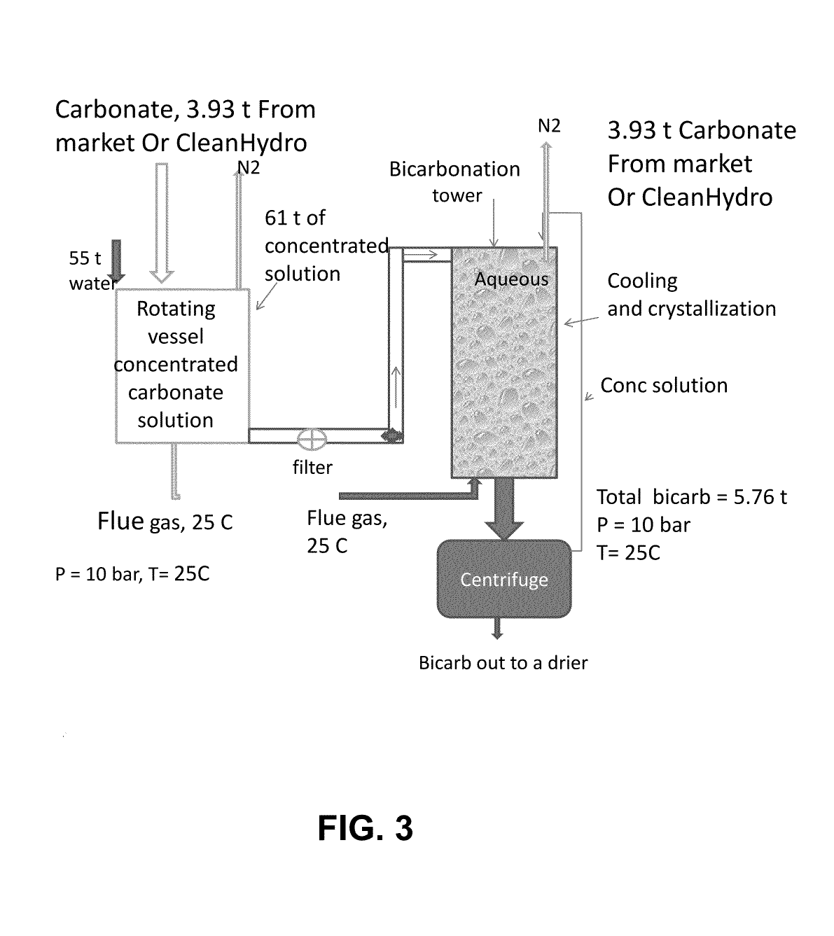

### DETAILED DESCRIPTION OF THE PREFERRED EMBODIMENTS WITH EXAMPLES

For the purposes hereof, “solid waste” or “municipal solid waste” (MSW) is shall be defined as consisting of, without limitation, food, kitchen waste, green waste, paper waste, glass, bottles, cans, metals, plastics, fabrics, clothes, batteries, construction and demolition waste, dirt, rocks, debris, electronic appliances, computer equipment, paints, chemicals, light bulbs and fluorescent lights, fertilizers, and medical waste.

For the purposes hereof, “refuse derived fuel” (RDF) is a combustible fuel commodity (e.g., without limitation, hydrogen, methane, methanol, ethanol or synthetic fuels) created by the treatment of solid waste.

For the purposes hereof, a “municipal solid waste plant” is a solid waste treatment plant involving the waste-to-energy process of creating energy or a combustible fuel commodity from the incineration of MSW or the indirect combustion of MSW through thermal reactions (e.g., without limitation, gasification or steam-fuel-reformation).

For the purposes hereof, “steam-fuel-reformation” means a method of hydrogen production from hydrocarbon fuels, wherein steam reacts with hydrocarbons as further disclosed herein below.

The present invention provides a novel method of sequestering carbon in RDF plants; the novelty lies in the fact that the RDF gases produced by burning MSW will not be released to the atmosphere but directed to a reactor for further conversion to hydrogen and bicarbonate.

The current industrial method of incineration generates several tonnes of carbon dioxide for each tonne of MSW. The method proposed here produces hydrogen and RDF with zero carbon emission. This is done by keeping all emissions (including that which provides the energy by burning MSW) together until the end stage of the series of reactions comprising of:

C+0.5 O2 ->CO (1000 C)

->(2 NaOH (melt)+C(s)+H2O (l)=Na2CO3-1(s)+2H2(g), 400 C) ->CO (400 C)

->(2 NaOH+CO=Na2CO3-2+H2)

->(Na2CO3-1+Na2CO3-2+H2O+CO2 (MSW))->Baking soda

Where Na2CO3-1 is the soda produced by the modified natural gas or coal reformation and the Na2CO3-2 is the carbonate produced in a second reactor.
Burning appropriate amount of coal or natural gas (NG) in limited oxygen or air (mixture of O₂ and N₂) to generate hot CO (˜1000 C)
the carbon (or NG) reaction in a reactor which produces hydrogen (H₂) and carbonate-1 with the energy provided by surrounding the reactor with hot CO and then passing all the gases (H₂, CO and N₂) at high temperature to the next reactor in which
the CO is fixed in a carbonate and gases consisting of H₂ (and N₂ if air is used); and a solid sellable carbonate-2 are produced; the solid is purified by recrystallization, and finally
the RDF flue gases from the MSW plant are reacted with the accumulated carbonate-1 and carbonate-2 to produce sodium bicarbonate,
because the heat produced in burning coal or gas and in carbonation exceeds the required heat for the reaction, by a proper engineering management of the endothermic (heat requiring) and exothermic (heat producing) reactions, we may need little or no additional energy to run the reactors.

The reactors could actually provide us not only hydrogen and carbonate but also relatively pure nitrogen. The mixed gases (N₂+H₂) can be directly used in ammonia plants or the gases can be separated for selling as needed. Most contaminants occurring in coal or gas are removed in the final reactor as solids. A concentrated aqueous solution of carbonate is used to precipitate bicarbonate (baking soda) sequestering the CO₂ in the flue gas generated during RDF production.

The invention relies on processes described below.

### A Coal Based Reactor: Converting RDF CO2 to Baking Soda

The target is to sequester a minimum of 3 tonnes of CO2 from the MSW or fossil fuel burning plant. This will be done as follows:

C+0.5 O2 →CO (1000 C)

→(2 NaOH (melt)+C (s)+H2O (l)=Na2CO3-1 (s)+2 H2 (g), 400 C)

→CO (400 C)

→(2 NaOH+CO=Na2CO3-2+H2)

→(Na2CO3-1+Na2CO3-2+H2O+CO2 (flue gas MSW))→Baking soda

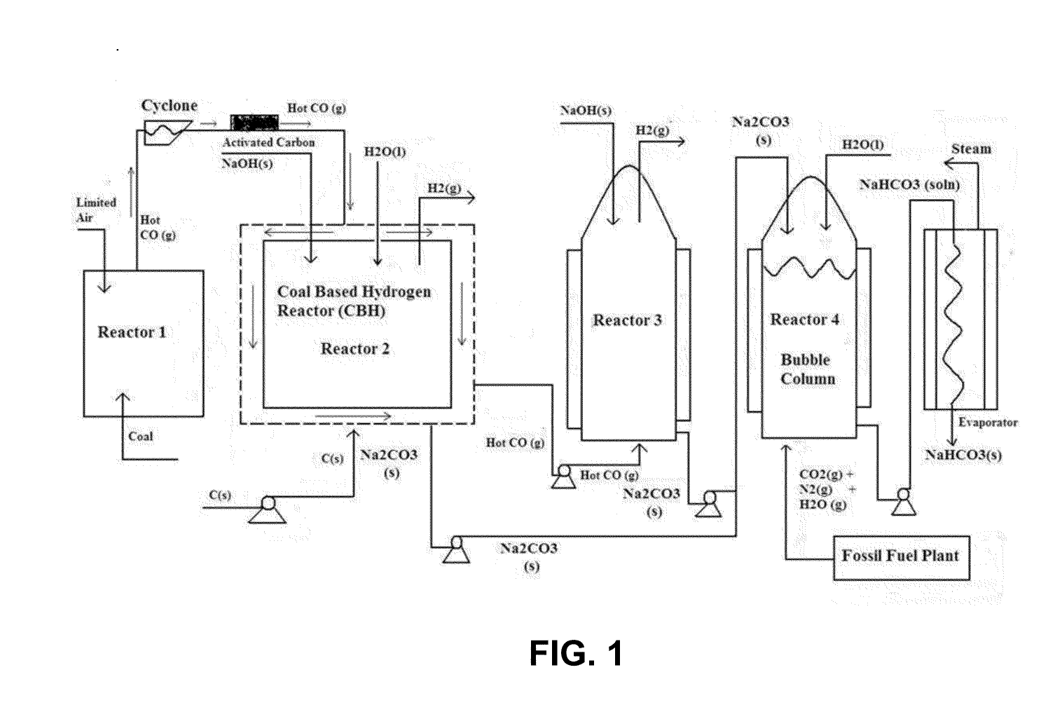

### (See FIG. 1)

Reactor 1: Energy production

C(s)+0.5 O2 (g)=CO (g)

T=25 C (exothermic reaction), ΔH=−196 kJ

The strategy is to produce enough CO at high temperature and use it for the modified steam-methane-reformation (see below)

Reactor 2: Carbonation

Reaction (moles) 2 NaOH (melt)+C (s)+H2O (l)=Na2CO3 (s)+2 H2 (g)

T=600 C, ΔH=130.8 kJ (endothermic)

Reactor 3: Second carbonation to absorb the CO from Reactor 2:

2 NaOH+CO=Na2CO3+H2

T=400 C, ΔH=−104 kJ

Reactor 4: Baking soda

Na2CO3 (s)+H2O (g)+CO2 RDF flue gas)=2NaHCO3

T=125 C, ΔH=−154 kJ

### Mass and Energy Balance

Target sequestration of >3 tonnes of CO2 per hour from any fossil fuel burning plant

Reactor 1: C (s)+0.5 O2 (g)=CO (g), T=25 C (exothermic reaction), ΔH=−196 kJ (moles)

Carbon = 501 Kg
O2 = 668 Kg
CO = 1.17 tonnes (1000 C.)

Total heat produced 3.68 E9 J to be used to provide energy to Reactor 1.

Reactor 2: 2 NaOH (melt)+C (s)+H2O (l)=Na2CO3 (s)+2 H2 (g); ΔH=130.8 kJ at 600 C (moles)

| | |
|---|---|
| NaOH, 2.064 tonnes (25 C.) | H2 103 kg |
| H2O 464 Kg (25 C.) | Soda 2.735 tonnes |
| C 310 Kg (25 C.) | |

The heat absorbed is 3.371 E9 J at 600 C. (This temperature could be lower close to 400 C). The CO flows around the Reactor II and is fed into the Reactor 3.

Reactor 3: 2 NaOH+CO=Na2CO3+H2, exothermic, ΔH=−104 kJ at 400 C (moles)

| | |
|---|---|
| NaOH, 3.39 tonnes (25 C.) | H2, 85 Kg |
| CO, 1.187 tonnes (400 C.) | Soda, 4.492 tonnes |

The heat produced is 4.879 E9 J at 400 C

Reactor 4: Na2CO3 (s)+H2O (g)+CO2 (g)=2NaHCO3, T=50C, ΔH=−87 KJ (moles)

Flue gas composition 3 tonnes CO2, 1.05 tonne H2O, 11 tonnes N2 (all gases at 125 C)

| | |
|---|---|
| Na2CO3 (Reactor 1), 2.735 tonnes | |
| Na2CO3 (Reactor 3), 4.492 tonnes | |
| Total soda, 7.227 tonnes (25 C.) | Total bicarbonate NaHCO3, |
| CO2 from RDF plant 3.00 tonnes (125 C.) | 11.455 tonnes |
| H2O (g) 1.05 tonnes (125 C.) | Hydrogen 188 Kg |
| H2O (1) 0.177 tonnes (25 C.) | |
| N2 (g) 11 tonnes (125 C.) | |

Heat produced 9.41E9 J at 100 C

### Summary

| Input | output |
|---|---|
| Oxygen 668 Kg | NaHCO3 (baking soda) 11.455 tonnes |
| CO2 3.0 tonnes | H2 188 Kg (energy value = 7415 kWh) |
| Carbon 811 Kg | Heat produced 10430 MJ or 2897 kWh |
| NaOH 5.454 tonnes | |
| H2O 1.691 tonnes | |

### A Natural Gas Based Reactor: Converting RDF CO2 to Baking Soda

The target is to sequester a minimum of 3 tonnes of CO2 from the fossil fuel or MSW burning plant. This will be done as follows:

C+0.5 O2 -→CO (1000 C)

-→(2 NaOH (melt)+CH4 (g)+H2O (l)=Na2CO3 (s)+4 H2 (g))→CO (400 C)→(2 NaOH+CO=Na2CO3-2+H2)→(Na2CO3-1+Na2CO3-2+H2O+CO2 (MSW))→Baking soda

Reactor 1: Energy production

C (s)+0.5 O2 (g)=CO (g)

T=25 C (exothermic reaction), ΔH=−196 kJ

Reactor 2: Carbonation

Reaction (moles) 2 NaOH (melt)+CH4 (g)+H2O (l)=Na2CO3 (s)+4 H2 (g)

T=400 C, ΔH=204 kJ (endothermic)

The strategy is to produce enough CO at high temperature and use it for the modified steam-methane-reformation (see below)

Reactor 3: Second carbonation to absorb the CO from Reactor 2:

2 NaOH+CO=Na2CO3+H2

T=400 C, ΔH=−104 kJ

Reactor 4: Baking soda

Na2CO3 (s)+H2O (g)+CO2 (g)=2NaHCO3

T=125 C, ΔH=−154 kJ

### Mass and Energy Balance

Target sequestration of >3 tonnes of CO2 per hour from any fossil fuel burning plant

Reactor 1: C (s)+0.5 O2 (g)=CO (g), T=25 C (exothermic reaction), ΔH=−196 kJ (moles)

Carbon = 588 Kg
O2 = 784 Kg
CO = 1.372 tonnes (1000 C.)

Total heat produced 5.210E9 J to be used to provide energy to Reactor 2.

Reactor 2: 2 NaOH (melt)+CH4 (g)+H2O (l)=Na2CO3 (s)+4 H2 (g) T=400 C, ΔH=204 kJ (endothermic)

| | |
|---|---|
| NaOH, 1.552 tonnes (25 C.) | H2 155 kg |
| H2O 349 Kg (25 C.) | Soda 2.057 tonnes |
| CH4 310 Kg (25 C.) | |

The heat absorbed is 3.480e9 J at 400 C (there is room here to increase the contents to get more hydrogen). The CO flows around the Reactor II and is fed into the Reactor 3.

Reactor 3: 2 NaOH+CO=Na2CO3+H2, exothermic, ΔH=−104 kJ at 400 C (moles)

| | |
|---|---|
| NaOH, 3.902 tonnes (25 C.) | H2, 98 Kg |
| CO, 1.372 tonnes (400 C.) | Soda, 5.171 tonnes |

The heat produced is 5.69 E9 J at 400 C

Reactor 4: Na2CO3 (s)+H2O (g)+CO2 (g)=2NaHCO3, T=50C, ΔH=−87 KJ (moles)

Flue gas composition 3 tonnes CO2, 1.05 tonne H2O, 11 tonnes N2 (all gases at 125 C)

| | |
|---|---|
| Na2CO3 (Reactor 1), 2.057 tonnes | |
| Na2CO3 (Reactor 3), 5.17 tonnes | |
| Total soda, 7.227 tonnes (25 C.) | Total bicarbonate NaHCO3, |
| CO2 from RDF plant 3.00 tonnes (125 C.) | 11.455 tonnes |
| H2O (g) 1.05 tonnes (125 C.) | Hydrogen 253 Kg |
| H2O (1) 0.177 tonnes (25 C.) | |
| N2 (g) 11 tonnes (125 C.) | |

Heat produced 9.41E9 J at 50C; cooling may be needed.

### Summary

| Input | Output |
|---|---|
| Oxygen 784 Kg | NaHCO3 (baking soda) 11.455 tonnes |
| CO2 3.0 tonnes + N2 + H2O | H2 253 Kg (energy value = 9979 kWh) |
| (flue gas = 15 tonne) | |
| Carbon 588 Kg | Energy produced 3914 kWh |
| NaOH 5.454 tonnes | |
| H2O 1.576 tonnes | |

All temperature and energy calculations detailed herein above are approximations. Actual temperature and energy readings may vary up to 20% in either direction.

### Other Volatiles and Contaminants in Coal and Natural Gas

Sodium carbonate is a good absorbent for many of the contaminants. For example SO2 will react as follows: Na2CO3+SO2=Na2SO4+0.5CO2+0.5C

In presence of SO2, all Hg is either HgS or Hg2SO4. Both will precipitate as solids and are heavy solids easily separated during formation of the aqueous solution of Na2CO3.

Electrostatic precipitators (ESP's), wet or dry, can capture particulates like sorbents, fly ash, or soot, in a wide range of temperatures. These devices have been adapted to “ionic” household air cleaners.

Nitrogen oxides (NOx) occur in all fossil fuel combustion, through oxidation of atmospheric nitrogen (N2) and also from organic nitrogen fuel content, and flue gas NOx concentrations are enhanced by high combustion chamber temperatures. In the last reactor, the reactions at 400 C preclude the formation of any of these oxides. If there is a need for any for further purification, it can be added on to the reactor system in a manner similar to described on the DOE website and in the figure which shows a series of scrubbers to get a purified gas.

Finally if there are any unreacted residual gases (mainly CO), they will be removed by further pass(es) through the carbonate reaction. The oxygen in the flue gas forms with N2 an amount of NaNO3 which is more soluble than the bicarbonate and remains in solution.

The references cited here are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

What is claimed is:

1. A process to sequester carbon from the flue gases emitted by a municipal solid waste to energy plant comprising the steps of: (a) burning a mixture of an oxidant and municipal solid waste to generate flue gas and products of combustion; (b) streaming the generated flue gas and the products of combustion into a high-temperature reactor; (c) adding to said high-temperature reactor sufficient fuel and water to produce hydrogen and reaction products in a balanced steam-fuel-reformation reaction; (d) transferring the reaction products to a low-temperature reactor; and (e) combining the reaction products with sodium hydroxide in the low-temperature reactor to form sodium carbonate.

2. The process of claim 1, steps (a)-(e), further comprising the steps of: (f) feeding carbonate from the high-temperature reactor and low-temperature reactor vessels into a rotating vessel to make a concentrated solution of the carbonate; (g) feeding RDF gas (composition as given in the examples) into a fourth reactor with water and carbonate; (h) feeding precipitated bicabonate with solution in to a centrifuge where the bicarbonate crystals are separated and sent for drying; and (i) returning the remaining concentrated solution and repeating the process.

3. A process to sequester carbon from the flue gases emitted by municipal solid waste to energy.

4. The process of claim 1, further including any MSW plant which generates RDF gases.

5. The process of claim 1, further comprising the RDF gases with the composition CO₂, H₂O, N₂ and O₂.

6. The process of claim 1, further comprising wherein the oxidant of step (a) is coal.

7. The process of claim 1, further comprising wherein the oxidant of step (a) is natural gas.

8. The process of claim 1, further comprising wherein the flue gas and products of combustion of step (a) is mainly carbon dioxide.

9. The process of claim 1, further comprising wherein the sodium hydroxide of step (e) is adjusted to react with components of gas comprised of sulfur dioxide, nitric oxide, or both, to form removable solids.

10. The process of claim 1, further comprising wherein the reaction of step (c) comprises a direct conversion of NaOH to Na₂CO₃.

11. The process of claim 1, further comprising wherein the reaction of step (c) comprises reacting Na₂CO₃ with water and CO₂.

12. The process of claim 1, further comprising the step of continuously feeding fuel throughout the process.

13. The process of claim 1, further comprising the step of adding water when combining the products with sodium hydroxide to produce sodium bicarbonate.

14. A process to sequester carbon from the fuel burner exhaust gases municipal solid waste to energy plants comprising the steps of:
(a) burning a mixture of atmospheric air or oxygen and natural gas or coal to generate flue gas and products of combustion, comprising mainly carbon dioxide;
(b) streaming the generated flue gas and the products of combustion into a first reactor;
(c) passing all products of the reaction to a second reactor;
(e) combining the products with sodium hydroxide to react at a low temperature to form sodium carbonate; and
(f) crystallizing impurities by combining such impurities with soda and then removing them.
